(19) United States
(12) Patent Application Publication
(10) Pub. No.: US 2025/0053372 A1
(43) Pub. Date: Feb. 13, 2025

(54) METHOD AND SYSTEM FOR RESTRICTING FORWARDING OF VOICE DATA ON SMART PHONE DEVICES

(71) Applicant: JPMorgan Chase Bank, N.A., New York, NY (US)

(72) Inventors: Keerthichandra RAYAVARAPU, Hyderabad (IN); Sravanthi MUSKU, Hyderabad (IN)

(73) Assignee: JPMorgan Chase Bank, N.A., New York, NY (US)

(21) Appl. No.: 18/781,316

(22) Filed: Jul. 23, 2024

(30) Foreign Application Priority Data
Aug. 7, 2023 (IN) 202311052862

(51) Int. Cl. G06F 3/16; G10L 15/22; H04W 4/021

(52) U.S. Cl. CPC G06F 3/165; H04W 4/021; G10L 15/22

(57) ABSTRACT

A system and a method for restricting the forwarding of voice data received by a smart phone device to virtual voice assistants that are accessible via the smart phone device are provided. The method includes: receiving information indicating that at least one criterion for restricting the forwarding of voice data is satisfied; and activating a module that is configured to disable virtual voice assistants that are associated with the smart phone device, such that each of the disabled virtual voice assistants is rendered inoperative. The criteria may include a presence of the smart phone device at a premises associated with a commercial entity, such as an employer of a user of the smart phone device, and the information may include an indication that an identification card has been swiped at a terminal located at the premises and/or geographical location data collected by the smart phone device.

### CROSS-REFERENCE TO RELATED APPLICATIONS

This application claims priority benefit from Indian Application No. 202311052862, filed on Aug. 7, 2023 in the India Patent Office, which is hereby incorporated by reference in its entirety.

### BACKGROUND

### 1. Field of the Disclosure

This technology generally relates to methods and systems for restricting the forwarding of voice data received by a smart phone device to virtual voice assistants and other applications that are accessible via the smart phone device.

### 2. Background Information

For many individuals, a smart phone is a device that is indispensable for performing many functions. Smart phones are capable of receiving and interpreting voice data, and also for using voice data to prompt virtual voice assistants that are associated with various applications to respond to the voice data. For example, an individual that has a smart phone manufactured by Apple® can say “Hey Siri” and this voice data will typically prompt the virtual voice assistant associated with Apple® to respond to a voice data inquiry that is spoken by the individual.

One consequence of this capability is that the virtual voice assistants are continuously monitoring the incoming voice data signals, regardless of whether an actual response is generated. As a result of the monitoring, the virtual voice assistants may be employed to collect the voice data signals and then use the content thereof to make determinations about various types of information that may present an opportunity for commercial exploitation.

The possibility of commercial exploitation may be undesirable, especially when the smart phone is owned or administered by an outside entity, such as, for example, an employer of the individual. In this regard, the employer may prefer to avoid the possibility of commercial exploitation of such voice data by other entities, which may be competitors or otherwise adverse to the interests of the employer.

Accordingly, there is a need for systems and methods that are designed to restricting the forwarding of voice data received by a smart phone device to virtual voice assistants and other applications that are accessible via the smart phone device.

### SUMMARY

The present disclosure, through one or more of its various aspects, embodiments, and/or specific features or sub-components, provides, inter alia, various systems, servers, devices, methods, media, programs, and platforms for restricting the forwarding of voice data received by a smart phone device to virtual voice assistants and other applications that are accessible via the smart phone device.

According to an aspect of the present disclosure, a method for restricting a forwarding of voice data received by a mobile device is provided. The method includes: receiving, by the at least one processor, first information indicating that at least one predetermined criterion for restricting the forwarding of voice data is satisfied; and activating, by the at least one processor, a first module that is configured to disable at least one virtual voice assistant that is associated with the mobile device, such that each of the disabled at least one virtual voice assistant is rendered inoperative.

The at least one predetermined criterion may include a presence of the mobile device at a premises associated with a commercial entity.

The first information may include an indication that an identification card has been swiped at a terminal located at the premises.

The first information may include geographical location data collected by the mobile device.

The at least one predetermined criterion may include a usage of the mobile device for a purpose that relates to an activity of an employee that is associated with a commercial entity.

The first information may include login information indicating that the employee is at work.

The method may further include: receiving second information indicating that the at least one criterion is no longer satisfied; and deactivating the first module, such that each of the at least one virtual voice assistant is rendered operative.

The at least one virtual voice assistant may include at least one from among a Siri® virtual voice assistant associated with Apple®, an Alexa® virtual voice assistant associated with Amazon®, a Cortana® virtual voice assistant associated with Microsoft®, a Google® virtual voice assistant associated with Google®, and a Bixby® virtual voice assistant associated with Samsung®.

The mobile device may include at least one from among a smart phone, a tablet computing device, and a laptop computing device.

According to another embodiment, a computing apparatus for restricting a forwarding of voice data received by a mobile device is provided. The computing apparatus includes a processor; a memory; and a communication interface coupled to each of the processor and the memory. The processor is configured to: receive, via the communication interface, first information indicating that at least one predetermined criterion for restricting the forwarding of voice data is satisfied; and activate a first module that is configured to disable at least one virtual voice assistant that is associated with the mobile device, such that each of the disabled at least one virtual voice assistant is rendered inoperative.

The at least one predetermined criterion may include a presence of the mobile device at a premises associated with a commercial entity.

The first information may include an indication that an identification card has been swiped at a terminal located at the premises.

The first information may include geographical location data collected by the mobile device.

The at least one predetermined criterion may include a usage of the mobile device for a purpose that relates to an activity of an employee that is associated with a commercial entity.

The first information may include login information indicating that the employee is at work.

The processor may be further configured to: receive, via the communication interface, second information indicating that the at least one criterion is no longer satisfied; and deactivate the first module, such that each of the at least one virtual voice assistant is rendered operative.

The at least one virtual voice assistant may include at least one from among a Siri® virtual voice assistant associated with Apple®, an Alexa® virtual voice assistant associated with Amazon®, a Cortana® virtual voice assistant associated with Microsoft®, a Google® virtual voice assistant associated with Google®, and a Bixby® virtual voice assistant associated with Samsung®.

The mobile device may include at least one from among a smart phone, a tablet computing device, and a laptop computing device.

According to yet another embodiment, a non-transitory computer readable storage medium storing instructions for restricting a forwarding of voice data received by a mobile device is provided. The storage medium includes a set of executable code which, when executed by a processor, causes the processor to: receive first information indicating that at least one predetermined criterion for restricting the forwarding of voice data is satisfied; and activate a first module that is configured to disable at least one virtual voice assistant that is associated with the mobile device, such that each of the disabled at least one virtual voice assistant is rendered inoperative.

The at least one predetermined criterion may include a presence of the mobile device at a premises associated with a commercial entity.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for restricting the forwarding of voice data received by a smart phone device to virtual voice assistants and other applications that are accessible via the smart phone device.

FIG. 4 is a flowchart of an exemplary process for implementing a method for restricting the forwarding of voice data received by a smart phone device to virtual voice assistants and other applications that are accessible via the smart phone device.

FIG. 5 is a diagram that illustrates a method for restricting the forwarding of voice data received by a smart phone device to virtual voice assistants and other applications that are accessible via the smart phone device, according to an exemplary embodiment.

FIG. 6 is a data flow diagram that illustrates an identity card swipe use case/scenario in a method for restricting the forwarding of voice data received by a smart phone device to virtual voice assistants and other applications that are accessible via the smart phone device, according to an exemplary embodiment.

FIG. 7 is a data flow diagram that illustrates a mobile geographical location detection use case/scenario in a method for restricting the forwarding of voice data received by a smart phone device to virtual voice assistants and other applications that are accessible via the smart phone device, according to an exemplary embodiment.

FIG. 8 is a data flow diagram that illustrates an employee work-from-home login use case/scenario in a method for restricting the forwarding of voice data received by a smart phone device to virtual voice assistants and other applications that are accessible via the smart phone device, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

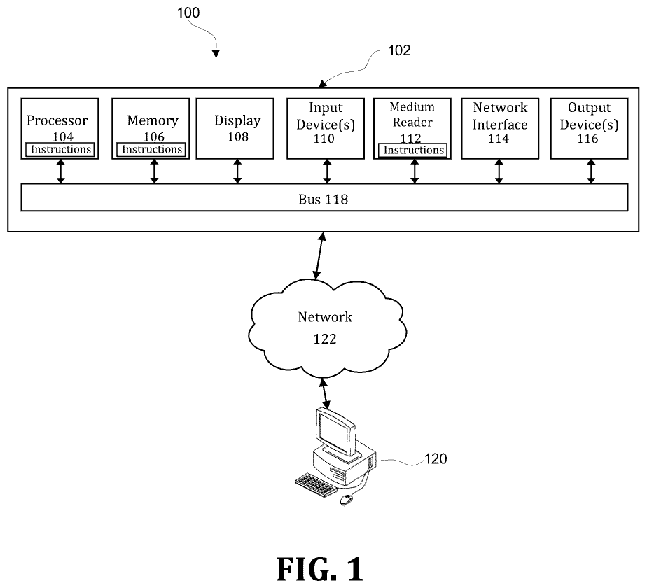

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

As described herein, various embodiments provide optimized methods and systems for restricting the forwarding of voice data received by a smart phone device to virtual voice assistants and other applications that are accessible via the smart phone device.

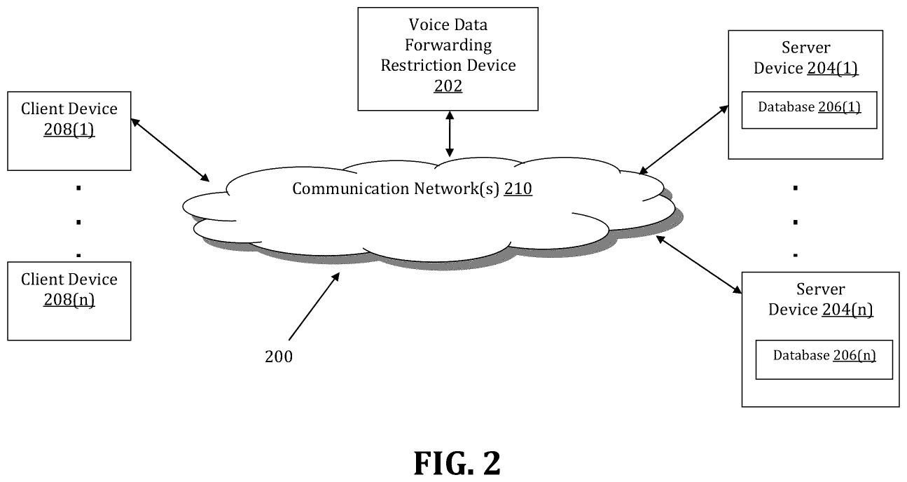

Referring to FIG. 2, a schematic of an exemplary network environment 200 for implementing a method for restricting the forwarding of voice data received by a smart phone device to virtual voice assistants and other applications that are accessible via the smart phone device is illustrated. In an exemplary embodiment, the method is executable on any networked computer platform, such as, for example, a personal computer (PC).

The method for restricting the forwarding of voice data received by a smart phone device to virtual voice assistants and other applications that are accessible via the smart phone device may be implemented by a Voice Data Forwarding Restriction (VDFR) device 202. The VDFR device 202 may be the same or similar to the computer system 102 as described with respect to FIG. 1. The VDFR device 202 may store one or more applications that can include executable instructions that, when executed by the VDFR device 202, cause the VDFR device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the VDFR device 202 itself, may be located in virtual server(s) running in a cloud-based computing environment rather than being tied to one or more specific physical network computing devices. Also, the application(s) may be running in one or more virtual machines (VMs) executing on the VDFR device 202. Additionally, in one or more embodiments of this technology, virtual machine(s) running on the VDFR device 202 may be managed or supervised by a hypervisor.

In the network environment 200 of FIG. 2, the VDFR device 202 is coupled to a plurality of server devices 204(1)-204(n) that hosts a plurality of databases 206(1)-206(n), and also to a plurality of client devices 208(1)-208(n) via communication network(s) 210. A communication interface of the VDFR device 202, such as the network interface 114 of the computer system 102 of FIG. 1, operatively couples and communicates between the VDFR device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the VDFR device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and VDFR devices that efficiently implement a method for restricting the forwarding of voice data received by a smart phone device to virtual voice assistants and other applications that are accessible via the smart phone device.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The VDFR device 202 may be a standalone device or integrated with one or more other devices or apparatuses, such as one or more of the server devices 204(1)-204(n), for example. In one particular example, the VDFR device 202 may include or be hosted by one of the server devices 204(1)-204(n), and other arrangements are also possible. Moreover, one or more of the devices of the VDFR device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the VDFR device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information that relates to device-specific criteria for restricting forwarding of voice data and information that relates to geographical locations at which voice data forwarding restrictions may be activated.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the VDFR device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the VDFR device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the VDFR device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the VDFR device 202, the server devices 204(1)-204(n), or the client devices 208(1)-208(n), for example, may be configured to operate as virtual instances on the same physical machine. In other words, one or more of the VDFR device 202, the server devices 204(1)-204(n), or the client devices 208(1)-208(n) may operate on the same physical device rather than as separate devices communicating through communication network(s) 210. Additionally, there may be more or fewer VDFR devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

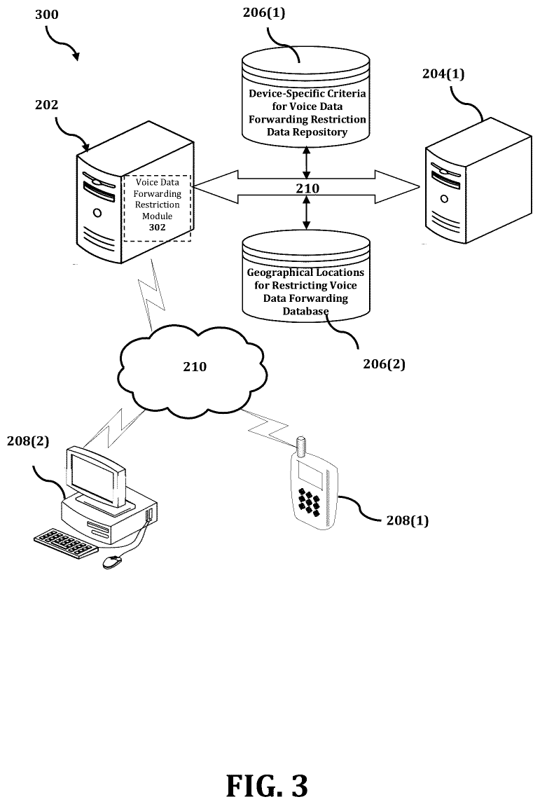

The VDFR device 202 is described and shown in FIG. 3 as including a voice data forwarding restriction module 302, although it may include other rules, policies, modules, databases, or applications, for example. As will be described below, the voice data forwarding restriction module 302 is configured to implement a method for restricting the forwarding of voice data received by a smart phone device to virtual voice assistants and other applications that are accessible via the smart phone device in an automated, efficient, scalable, and reliable manner.

An exemplary process 300 for implementing a method for restricting the forwarding of voice data received by a smart phone device to virtual voice assistants and other applications that are accessible via the smart phone device by utilizing the network environment of FIG. 2 is shown as being executed in FIG. 3. Specifically, a first client device 208(1) and a second client device 208(2) are illustrated as being in communication with VDFR device 202. In this regard, the first client device 208(1) and the second client device 208(2) may be “clients” of the VDFR device 202 and are described herein as such. Nevertheless, it is to be known and understood that the first client device 208(1) and/or the second client device 208(2) need not necessarily be “clients” of the VDFR device 202, or any entity described in association therewith herein. Any additional or alternative relationship may exist between either or both of the first client device 208(1) and the second client device 208(2) and the VDFR device 202, or no relationship may exist.

Further, VDFR device 202 is illustrated as being able to access a device-specific criteria for voice data forwarding restriction data repository 206(1) and a geographical locations for restricting voice data forwarding database 206(2). The voice data forwarding restriction module 302 may be configured to access these databases for implementing a method for restricting the forwarding of voice data received by a smart phone device to virtual voice assistants and other applications that are accessible via the smart phone device.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the VDFR device 202 via broadband or cellular communication. Of course, these embodiments are merely exemplary and are not limiting or exhaustive.

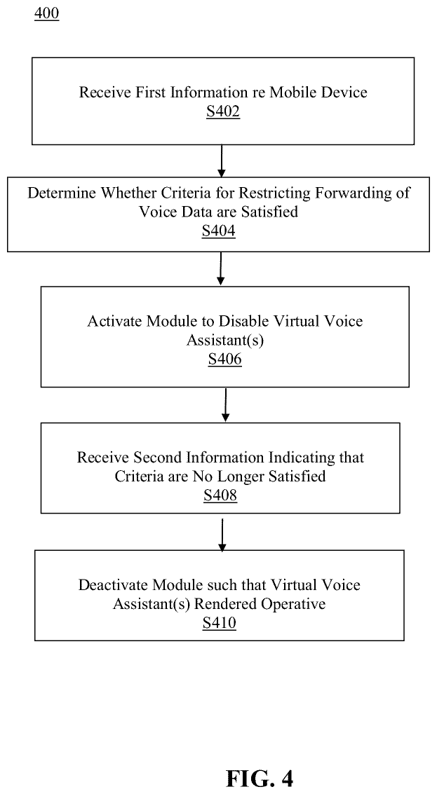

Upon being started, the voice data forwarding restriction module 302 executes a process for restricting the forwarding of voice data received by a smart phone device to virtual voice assistants and other applications that are accessible via the smart phone device. An exemplary process for restricting the forwarding of voice data received by a smart phone device to virtual voice assistants and other applications that are accessible via the smart phone device is generally indicated at flowchart 400 in FIG. 4.

In the process 400 of FIG. 4, at step S402, the voice data forwarding restriction module 302 receives first information that relates to a mobile device, such as, for example, a smart phone device, a tablet computing device, a laptop computing device, and/or any other suitable type of mobile device.

At step S404, the voice data forwarding restriction module 302 uses the first information to determine whether at least one predetermined criterion for restricting the forwarding of voice data is satisfied. In an exemplary embodiment, the criteria may include a presence of the mobile device at a premises associated with a commercial entity, such as, for example, an employer of a user of the mobile device. In this scenario, the first information may include an indication that an identification card has been swiped at a terminal located at the premises and/or geographical location data that corresponds to a geographical location of the premises.

Alternatively, the criteria may include a usage of the mobile device for a purpose that relates to an activity of an employee that is associated with a commercial entity. In this scenario, the first information may include login information indicating that the employee is at work. For example, when an employee is working from home, even though the mobile device is not located at the premises associated with the employer, it may be the case that the employee uses the mobile device to log in to the employer's system, thereby indicating that the employee is currently working.

At step S406, when a determination is made that the criteria are satisfied, the voice data forwarding restriction module 302 activates a module that is configured to disable at least one virtual voice assistant that is associated with the mobile device, thereby rendering the virtual voice assistants inoperative. In an exemplary embodiment, the at least one virtual voice assistant may include any one or more of a Siri® virtual voice assistant associated with Apple®, an Alexa® virtual voice assistant associated with Amazon®, a Cortana® virtual voice assistant associated with Microsoft®, a Google® virtual voice assistant associated with Google®, a Bixby® virtual voice assistant associated with Samsung®, and/or any other type of virtual voice assistant.

At step S408, the voice data forwarding restriction module 302 receives second information indicating that the criteria for restricting the forwarding of voice data are no longer satisfied. For example, the second information may include an additional swiping of an identification card and/or geographic location data that signifies that the mobile device is no longer located at the employer premises, and/or logout information indicating that the employee is no longer currently working. Then, at step S410, the voice data forwarding restriction module 302 deactivates the module, such that the virtual voice assistants are rendered operative.

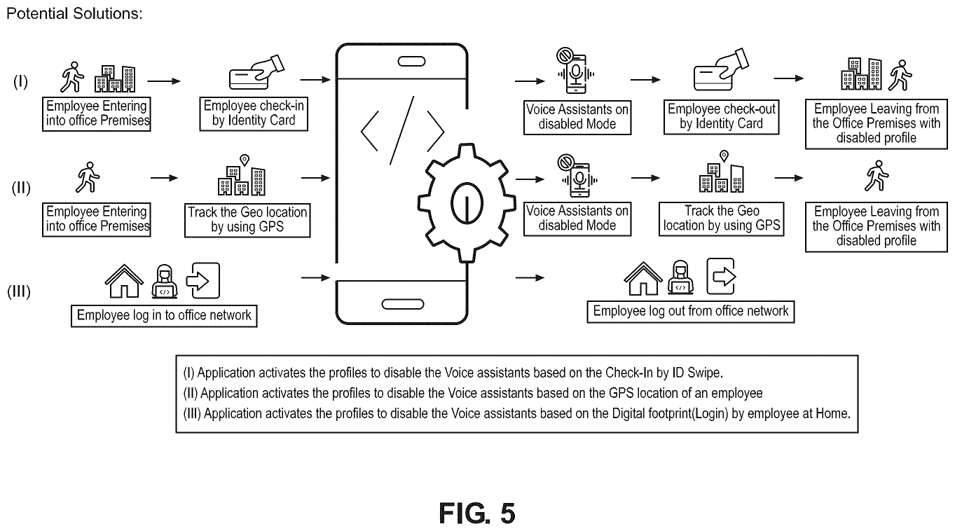

FIG. 5 is a diagram 500 that illustrates a method for restricting the forwarding of voice data received by a smart phone device to virtual voice assistants and other applications that are accessible via the smart phone device, according to an exemplary embodiment. As shown in FIG. 5, the mobile device may be a smart phone, and there are three parallel paths by which the method is executable. In a first path, an employee enters into office premises and checks in by using an identity card. This act of checking in by swiping the identity card triggers the activation of a profile in order to disable the virtual voice assistants that relate to the smart phone. The virtual voice assistants remain in disabled mode for the duration of the time that the employee is on the office premises. Then, when the employee checks out by swiping the identity card again, the employee leaves from the office premises, and the profile is deactivated, thereby re-enabling the virtual voice assistants such that they are operative while the employee is no longer at the office.

Referring again to FIG. 5, in a second path, the employee enters into office premises, and a geographical positioning system (GPS) that is associated with the smart phone collects geographical location data that corresponds to the location of the smart phone. The fact that the GPS data indicates that the smart phone is now located at the office premises triggers the activation of the profile in order to disable the virtual voice assistants that relate to the smart phone. The virtual voice assistants remain in disabled mode for the duration of the time that the employee is on the office premises. Then, when the employee leaves from the office premises, the GPS data indicates that the smart phone is no longer located at the office premises and thus the profile is deactivated, thereby re-enabling the virtual voice assistants such that they are operative while the employee is no longer at the office.

Referring again to FIG. 5, in a third path, the employee logs in to an office network, and the act of logging in generates a digital footprint that indicates that the employee is now “at work,” i.e., functioning in an employee role. The fact that digital footprint indicates the “at work” status triggers the activation of the profile in order to disable the virtual voice assistants that relate to the smart phone. The virtual voice assistants remain in disabled mode for the duration of the time that the employee remains “at work”. Then, when the employee logs out from the office network, the digital footprint is disabled, thereby indicating that the employee is now not at work, and thus the profile is deactivated, thereby re-enabling the virtual voice assistants such that they are operative while the employee is no longer at work.

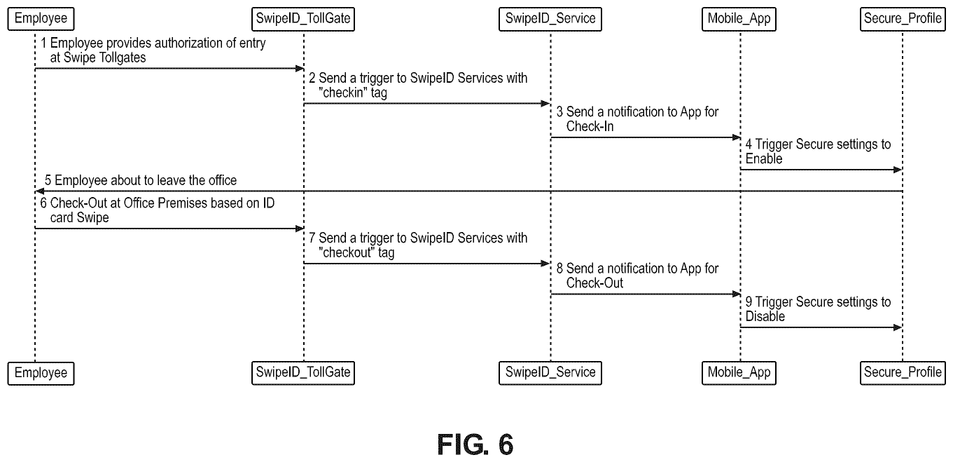

FIG. 6 is a data flow diagram 600 that illustrates an identity card swipe use case/scenario in a method for restricting the forwarding of voice data received by a smart phone device to virtual voice assistants and other applications that are accessible via the smart phone device, according to an exemplary embodiment. As shown in data flow diagram 600, in a first step, an employee provides authorization of entry onto office premises at a swipe tollgate by swiping an identification (ID) card. In a second step, the swipe tollgate sends a trigger to a SwipeID Services server with a “checkin” tag. In a third step, the SwipeID Services server sends a notification to an application that resides on a mobile smart phone of the employee in order to notify the application that the employee has checked in for work. In a fourth step, the application triggers secure settings in order to enable a profile by which the virtual voice assistants that relate to the employee's smart phone are disabled. In a fifth step, the virtual voice assistants remain in disabled mode for the duration of the time that the employee is on the office premises, i.e., until the employee is ready to leave the office.

Referring again to data flow diagram 600, in a sixth step, when the employee checks out by swiping the identity card again at the swipe tollgate, the employee leaves from the office premises. In a seventh step, the swipe tollgate sends a trigger to the SwipeID Services server with a “checkout” tag. Then, in an eighth step, the SwipeID Services server sends a notification to the application in order to notify the application that the employee has checked out, and then, in a ninth step, the profile is deactivated, thereby re-enabling the virtual voice assistants such that they are operative while the employee is no longer at the office.

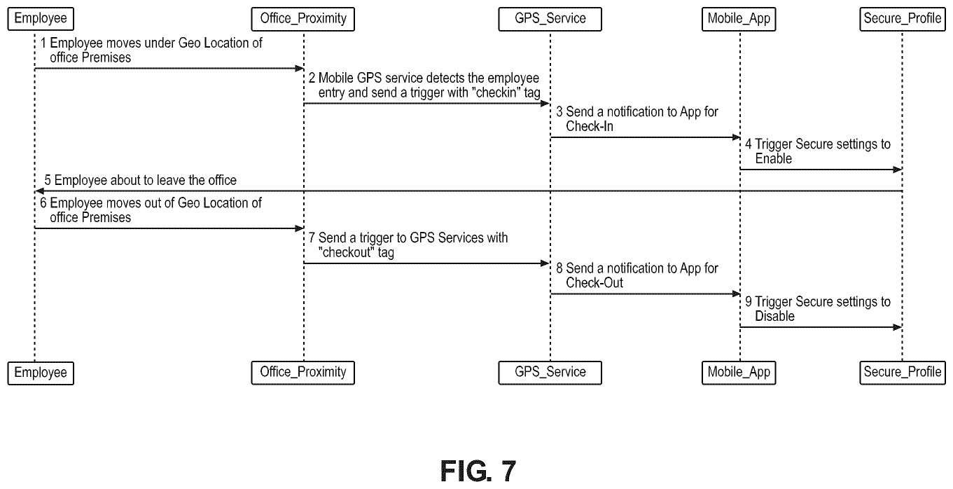

FIG. 7 is a data flow diagram 700 that illustrates a mobile geographical location detection use case/scenario in a method for restricting the forwarding of voice data received by a smart phone device to virtual voice assistants and other applications that are accessible via the smart phone device, according to an exemplary embodiment. As shown in data flow diagram 700, in a first step, the employee enters into office premises. In a second step, a geographical positioning system (GPS) that is associated with the smart phone collects geographical location data that corresponds to the location of the smart phone. The fact that the GPS data indicates that the smart phone is now located at the office premises prompts the transmission of a trigger to a GPS Services server with a “checkin” tag. In a third step, the GPS Services server sends a notification to an application that resides on a mobile smart phone of the employee in order to notify the application that the employee has checked in for work. In a fourth step, the application triggers secure settings in order to enable a profile by which the virtual voice assistants that relate to the employee's smart phone are disabled. In a fifth step, the virtual voice assistants remain in disabled mode for the duration of the time that the employee is on the office premises, i.e., until the employee is ready to leave the office.

Referring again to data flow diagram 700, in a sixth step, the employee leaves from the office premises. In a seventh step, the GPS that is associated with the employee's smart phone collects geographical location data that corresponds to the location of the smart phone, and the fact that the GPS data indicates that the smart phone is no longer located at the office premises prompts the transmission of a trigger to the GPS Services server with a “checkout tag. Then, in an eighth step, the GPS Services server sends a notification to the application in order to notify the application that the employee has checked out, and then, in a ninth step, the profile is deactivated, thereby re-enabling the virtual voice assistants such that they are operative while the employee is no longer at the office.

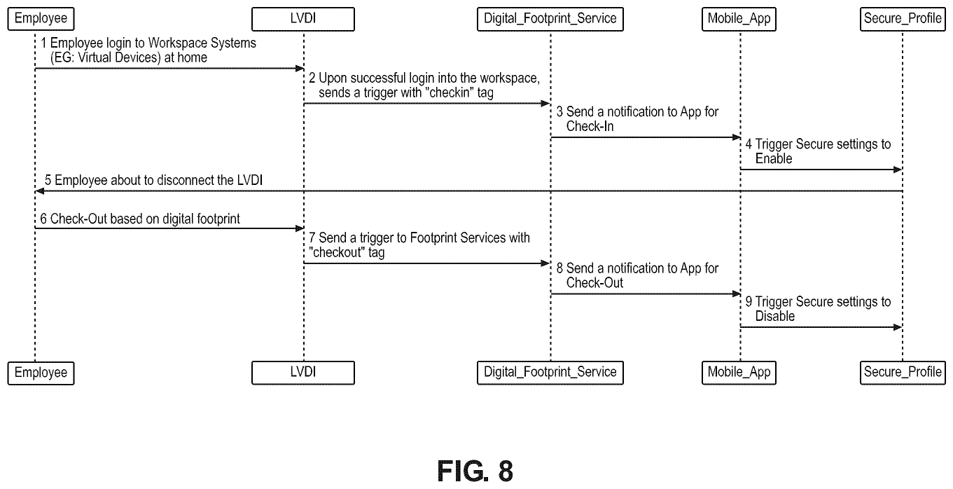

FIG. 8 is a data flow diagram 800 that illustrates an employee work-from-home login use case/scenario in a method for restricting the forwarding of voice data received by a smart phone device to virtual voice assistants and other applications that are accessible via the smart phone device, according to an exemplary embodiment. As shown in data flow diagram 800, in a first step, an employee logs in to an office network system that is associated with an employer workspace, such as, for example, a local virtual desktop infrastructure (LVDI) network that is configured to facilitate working from home or remotely. The act of logging in indicates that the employee is “at work”, i.e., functioning in the employee role. In a second step, the LVDI sends a trigger to a Digital Footprint Services server with a “checkin” tag. In a third step, the Digital Footprint Services server sends a notification to an application that resides on a mobile smart phone of the employee in order to notify the application that the employee has checked in for work. In a fourth step, the application triggers secure settings in order to enable a profile by which the virtual voice assistants that relate to the employee's smart phone are disabled. In a fifth step, the virtual voice assistants remain in disabled mode for the duration of the time that the employee is “at work”.

Referring again to data flow diagram 800, in a sixth step, the employee checks out by logging out of the LDVI, thereby signifying that the employee is no longer “at work”. In a seventh step, the LDVI sends a trigger to the Digital Footprint Services server with a “checkout” tag. Then, in an eighth step, the Digital Footprint Services server sends a notification to the application in order to notify the application that the employee has checked out, and then, in a ninth step, the profile is deactivated, thereby re-enabling the virtual voice assistants such that they are operative while the employee is no longer at work.

Accordingly, with this technology, an optimized process for restricting the forwarding of voice data received by a smart phone device to virtual voice assistants and other applications that are accessible via the smart phone device is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for restricting a forwarding of voice data received by a mobile device, the method being implemented by at least one processor that is associated with the mobile device, the method comprising:
receiving, by the at least one processor, first information indicating that at least one predetermined criterion for restricting the forwarding of voice data is satisfied; and
activating, by the at least one processor, a first module that is configured to disable at least one virtual voice assistant that is associated with the mobile device, such that each of the disabled at least one virtual voice assistant is rendered inoperative.

2. The method of claim 1, wherein the at least one predetermined criterion comprises a presence of the mobile device at a premises associated with a commercial entity.

3. The method of claim 2, wherein the first information includes an indication that an identification card has been swiped at a terminal located at the premises.

4. The method of claim 2, wherein the first information includes geographical location data collected by the mobile device.

5. The method of claim 1, wherein the at least one predetermined criterion comprises a usage of the mobile device for a purpose that relates to an activity of an employee that is associated with a commercial entity.

6. The method of claim 5, wherein the first information includes login information indicating that the employee is at work.

7. The method of claim 1, further comprising:
receiving second information indicating that the at least one criterion is no longer satisfied; and
deactivating the first module, such that each of the at least one virtual voice assistant is rendered operative.

8. The method of claim 1, wherein the at least one virtual voice assistant includes at least one from among a Siri® virtual voice assistant associated with Apple®, an Alexa® virtual voice assistant associated with Amazon®, a Cortana® virtual voice assistant associated with Microsoft®, a Google® virtual voice assistant associated with Google®, and a Bixby® virtual voice assistant associated with Samsung®.

9. The method of claim 1, wherein the mobile device comprises at least one from among a smart phone, a tablet computing device, and a laptop computing device.

10. A computing apparatus for restricting a forwarding of voice data received by a mobile device, the computing apparatus comprising:
a processor;
a memory; and
a communication interface coupled to each of the processor and the memory,
wherein the processor is configured to:
receive, via the communication interface, first information indicating that at least one predetermined criterion for restricting the forwarding of voice data is satisfied; and
activate a first module that is configured to disable at least one virtual voice assistant that is associated with the mobile device, such that each of the disabled at least one virtual voice assistant is rendered inoperative.

11. The computing apparatus of claim 10, wherein the at least one predetermined criterion comprises a presence of the mobile device at a premises associated with a commercial entity.

12. The computing apparatus of claim 11, wherein the first information includes an indication that an identification card has been swiped at a terminal located at the premises.

13. The computing apparatus of claim 11, wherein the first information includes geographical location data collected by the mobile device.

14. The computing apparatus of claim 10, wherein the at least one predetermined criterion comprises a usage of the mobile device for a purpose that relates to an activity of an employee that is associated with a commercial entity.

15. The computing apparatus of claim 14, wherein the first information includes login information indicating that the employee is at work.

16. The computing apparatus of claim 10, wherein the processor is further configured to:
receive, via the communication interface, second information indicating that the at least one criterion is no longer satisfied; and
deactivate the first module, such that each of the at least one virtual voice assistant is rendered operative.

17. The computing apparatus of claim 10, wherein the at least one virtual voice assistant includes at least one from among a Siri® virtual voice assistant associated with Apple®, an Alexa® virtual voice assistant associated with Amazon®, a Cortana® virtual voice assistant associated with Microsoft®, a Google® virtual voice assistant associated with Google®, and a Bixby® virtual voice assistant associated with Samsung®.

18. The computing apparatus of claim 10, wherein the mobile device comprises at least one from among a smart phone, a tablet computing device, and a laptop computing device.

19. A non-transitory computer readable storage medium storing instructions for restricting a forwarding of voice data received by a mobile device, the storage medium comprising executable code which, when executed by a processor, causes the processor to:
receive first information indicating that at least one predetermined criterion for restricting the forwarding of voice data is satisfied; and
activate a first module that is configured to disable at least one virtual voice assistant that is associated with the mobile device, such that each of the disabled at least one virtual voice assistant is rendered inoperative.

20. The storage medium of claim 19, wherein the at least one predetermined criterion comprises a presence of the mobile device at a premises associated with a commercial entity.
